(19) United States
(12) Patent Application Publication
(10) Pub. No.: US 2003/0206113 A1
(43) Pub. Date: Nov. 6, 2003

(54) Method of controlling keyboard to indicate incoming e-mail

(76) Inventor: Peter Chen, Taipei (TW)

Correspondence Address: RABIN & BERDO, P.C., Suite 500, 1101 14th Street, N.W., Washington, DC, 20005, US

(21) Appl. No.: 10/138,499

(22) Filed: May 6, 2002

(51) Int. Cl. G08B 5/22

(52) U.S. Cl. 340/815.45; 340/691.1

(57) ABSTRACT

In a method of controlling keyboard to indicate incoming e-mail, a specific driver is designed to repeatedly detect any new incoming e-mail received on a computer and any unread incoming e-mail in an inbox of the computer. A user is informed of the unread incoming e-mail via existing indicators on the keyboard connected to the computer. It does not need to add any new key to the keyboard or to modify settings and/or circuit elements for a controller of the keyboard to indicate the incoming e-mail via the keyboard.

### FIELD OF THE INVENTION

The present invention relates to a method of indicating incoming e-mail, and more particularly to a method of informing a user of an incoming e-mail via a keyboard without the need of adding any new key thereto or modifying settings or circuit elements of a controller thereof.

### BACKGROUND OF THE INVENTION

The use of e-mails has become very popular with the increasing development of Internet. E-mail not only saves a lot of time and cost that is otherwise needed for sending mails in conventional manners, but also meets the concept of environmental protection through largely reduced use of paper.

Conventional ways for informing a user of an incoming e-mail in real time include showing a message on a computer screen via a remind-on-screen program and/or emitting a sound via a speaker connected to the computer. A prerequisite for these ways to work is the user must be looking at the screen and/or a speaker must be connected to the computer.

There are also keyboards developed by computer peripheral manufacturers to indicate and inform a user of an incoming e-mail by adding a load, such as a light emitting diode or a current-limiting resistor, to the circuit of the keyboards; modifying firmware inside the keyboard controllers; or adding an I/O port for serving as a signal output terminal of the keyboard controllers. When there is an incoming e-mail received on the computer and the keyboard controller is informed of such received e-mail, a driving signal is output by the signal output terminal of the keyboard controller to energize the load, that is, to drive the light emitting diode to emit light, so that the user in front of the computer or the keyboard is informed of the incoming e-mail. However, this way necessitates modification of relevant circuits or controller and molds for the keyboard. In other words, the above-described keyboards for indicating incoming e-mail are actually specially structured keyboards that require increased manufacturing cost and must be separately purchased and therefore form a burden to users.

It is therefore tried by the inventor to develop an improved way to eliminate the above-mentioned drawbacks in informing a user of an incoming e-mail via a keyboard, enabling the user to know and take care of the incoming e-mail in real time without the need of looking at the computer screen and/or closing some programs.

### SUMMARY OF THE INVENTION

A primary object of the present invention is to provide a method of controlling keyboard to indicate any new incoming e-mail. To achieve the above and other objects, the present invention uses a specific driver to repeatedly detect any new incoming e-mail received on a computer. The driver generates a Set Keyboard State function if there is any unread incoming e-mail that has been put in an inbox. A user is informed of the unread incoming e-mail directly from existing indicators on a keyboard connected to the computer. It does not need to add any new key to the keyboard or to modify settings and/or circuit elements for a controller thereof. The problems of increased manufacturing cost of keyboard due to added light emitting diode or current-limiting resistor and additional expenses incurred by users to purchase the modified keyboard are therefore avoided.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the controlling steps included in the method according to a preferred embodiment of the present invention;

FIG. 2 is a flowchart showing the controlling steps included in the method according to another preferred embodiment of the present invention; and

FIG. 3 is a logic circuit diagram embodying the method of the present invention.

### DETAILED DESCRIPTION OF THE PREFERRED EMBODIMENTS

The present invention relates to a method of controlling keyboard to indicate incoming e-mail. The keyboard used in the present invention is a standard keyboard being provided on a top surface with all necessary keys, including arrow keys for moving the cursor, numeric keys, Num Lock key, Scroll Lock key, Caps Lock key, Shift key, Insert key, Delete key, Home key, End key, etc., as well as indicators that are usually located at an upper right corner of the standard keyboard to indicate current states of Num Lock, Scroll Lock, and Caps Lock keys. These indicators are usually light emitting diodes (LED) electrically connected to I/O ports of a controller for controlling an internal circuit configuration of the keyboard. Usually, these light emitting diodes are caused to emit light by way of current sinking.

Please refer to the following Table 1 that shows bits representing different indicators on the keyboard, and Table 2 that shows host commands used in the present invention and different state combinations of Caps Lock, Num Lock, and Scroll Lock indicators corresponding to these host commands.

TABLE 1

| Bit | Indicator |
|---|---|
| 0 | Scroll Lock Indicator for controlling the |
| | state of the Scroll Lock key. |
| 1 | Num Lock Indicator for controlling the |
| | state of the Num Lock key. |
| 2 | Caps Lock Indicator for controlling the |
| | state of the Caps Lock key. |

TABLE 2

| | State of | State of | State of |
|---|---|---|---|
| Host | Caps Lock | Num Lock | Scroll Lock |
| Command | Indicator | Indicator | Indicator |
| ED 00 H | OFF | OFF | OFF |
| ED 01 H | OFF | OFF | ON |
| ED 02 H | OFF | ON | OFF |
| ED 03 H | OFF | ON | ON |
| ED 04 H | ON | OFF | OFF |
| ED 05 H | ON | OFF | ON |
| ED 06 H | ON | ON | OFF |
| ED 07 H | ON | ON | ON |

It is known that the existing Windows system uses a register to detect flag bits separately for the Scroll Lock, the Num Lock, and the Caps Lock keys on the standard keyboard, in order to change the states of the LED indicators on the same keyboard corresponding to these keys. Based on this principle, a driver is designed by the inventor to detect any new incoming e-mail received on a computer and put in an inbox of the computer. Wherein, the driver will continuously or intermittently send out a Set Keyboard State function to change the flag bits of the Scroll Lock, the Num Lock, and the Caps Lock key on a keyboard connected to the computer. The changed flag bits are converted by an operating system of the computer into codes in the form of ED XX H, which are continuously sent to the keyboard controller via a signal line or transmission line at a cycle of 0.5 second, so as to change the ON and OFF states of the LED indicators on the keyboard.

As can be seen in Table 2, the controller of a known standard keyboard may receive from a host of the computer the host commands numbered from ED 00 H to ED 07 H representing total eight state combinations for three different bits, that is, the states of the ScrollLock, theCapsLock, andtheNumLockindicators. In other words, when the computer sends out the host command ED 00 H, all three LED indicators on the keyboard are OFF, and when the computer sends out the host command ED 07 H, all three LED indicators on the keyboard are ON. Since there is a time difference between two continuously sent ED XX H commands, a visually warning effect is produced via the currently indicated state combination of the three indicators. This enables a user to know a new incoming e-mail via the indicators on the keyboard and to take care of the new incoming e-mail in real time without the need of always looking at the computer screen or closing a part of currently executed programs.

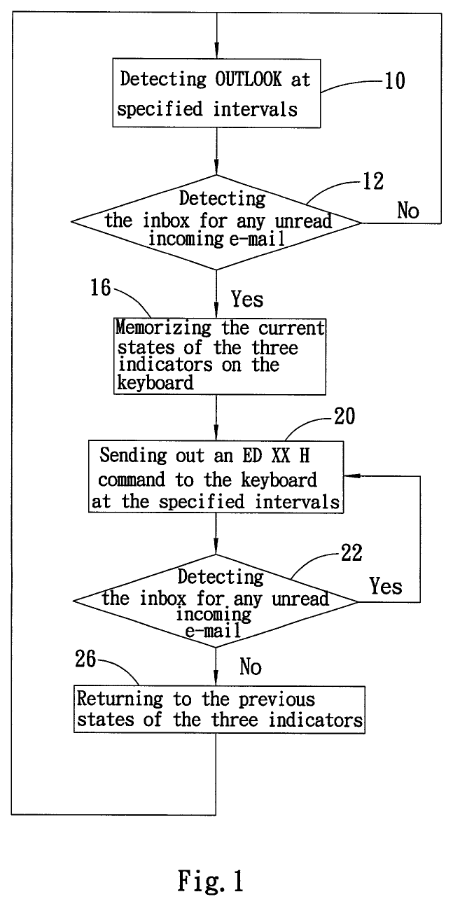

Please refer to FIG. 1 that is a flowchart showing the controlling steps included in the method according to a preferred embodiment of the present invention. In the method of the present invention, the specific driver repeatedly detects any new incoming e-mail received on a computer, and detects whether the new incoming e-mail received on the computer, if any, is put in an inbox of the computer. If there is any unread new incoming e-mail in the inbox, existing indicators on a keyboard connected to the computer are made to inform the user of the new and unread incoming e-mail. The detailed steps in which the driver detects and informs the user of the new incoming e-mails via the existing indicators on the keyboard are as follows:

1. Detects the inbox for any incoming e-mail at specified intervals (10);

2. Detects the inbox for any unread incoming e-mail (12);

3. Memorizes the current states of the three indicators on the keyboard, if there is any unread incoming e-mail in the inbox (16) and goes to the next step; or return to the step 10, if there is not any unread incoming e-mail in the inbox;

4.Sends out a host command ED XX H corresponding to the current states of the three indicators to the keyboard at the specified intervals (20), so that the user is informed of the new (unread) incoming e-mail via the indicators on the keyboard that light or extinguish corresponding to the sent host command;

5. Detects the inbox again for any unread incoming e-mail (22); and

6. Returns to the previously memorized states of the indicators, if there is not any unread incoming e-mail in the inbox (26); or return to the step (20), if there is any unread incoming e-mail in the inbox. After the step (26), the driver continues the detection at the specified intervals for any new incoming e-mail (10).

In brief, the user can be automatically informed of any new incoming e-mail directly through the existing indicators on the keyboard, in order to handle the new incoming e-mail in real time.

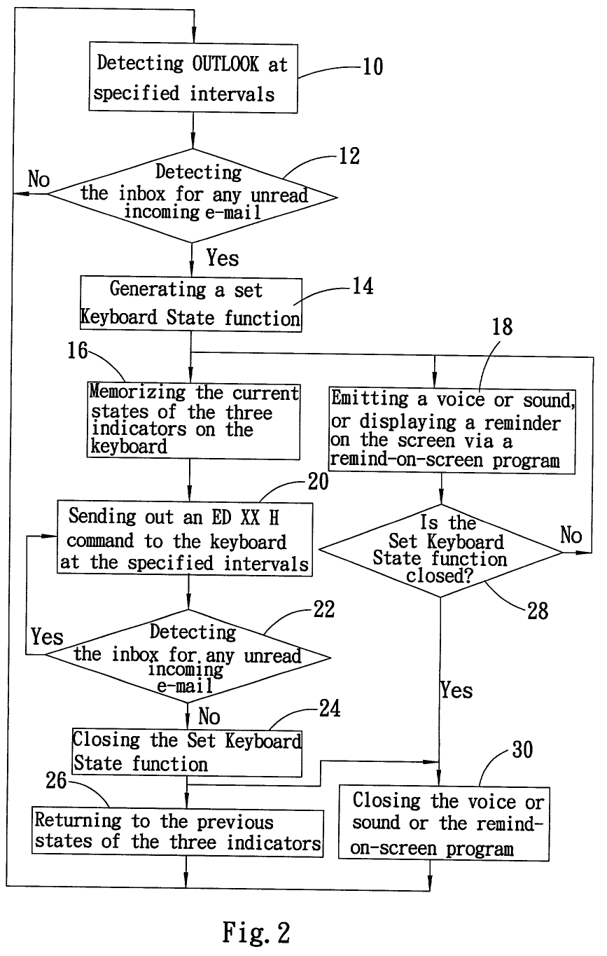

FIG. 2 is a flowchart showing detailed controlling steps executed by the specific driver to implement the method according to another preferred embodiment of the present invention, in which a speaker or a remind-on-screen program is incorporated to inform the user of a new incoming e-mail. The steps include:

1. Detects the inbox for any incoming e-mail at specified intervals (10);

2. Detects the inbox for any unread incoming e-mail (12);

3. Generates a Set Keyboard State function, if there is any unread incoming e-mail in the inbox (14); or returns to the step 10, if there is not any unread incoming e-mail in the inbox;

4. In the case the Set Keyboard State function is generated, the current states of the three indicators on the keyboard are memorized (16), a host command ED XX H corresponding to the current states of the three indicators are sent to the keyboard at the specified intervals (20), and the inbox are detected repeatedly for any unread incoming e-mail (22); and meanwhile, a voice or sound is sent out via a speaker connected to the computer or a reminder is displayed on the screen via a remind-on-screen program (18) ; so that a user is informed of the new and unread incoming e-mail via the indicated states of the indicators on the keyboard, the emitted voice or sound, and/or a reminding message shown on the screen;

5. Returns to the step (20), if any unread incoming e-mail is detected in the inbox in the step (22); or closes the Set Keyboard State function (24), if no unread incoming e-mail is detected in the inbox, and returns to the previously memorized states of the indicators (26);

6. Meanwhile, checks whether the Set Keyboard State function has been closed (28) after the step (18); if not, returns to the step (18); and if yes, the voice or sound or the remind-on-screen program is closed (30); and

7. Returns to the step (10) and repeats other steps in the above-described manner, in order to inform the user of any new incoming e-mail at the specified intervals.

With the existing indicators on the keyboard and the speaker and the remind-on-screen program, the user is automatically informed of the incoming e-mail to take care of it in real time.

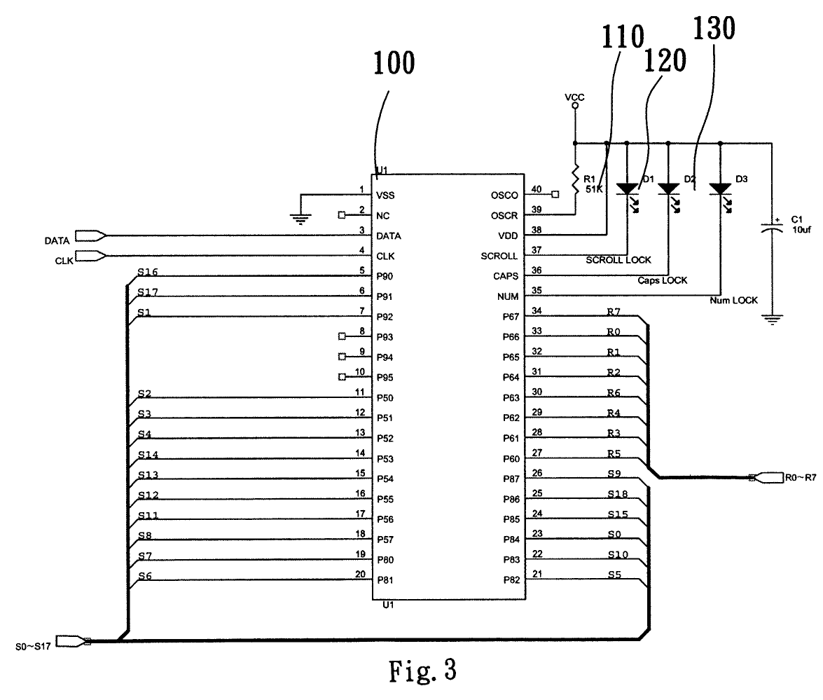

It is to be noted that the three LED indicators are used at the same time in the method of the present invention to control the keyboard for indicating any incoming e-mail. FIG. 3 is a logic circuit diagram embodying the method of the present invention. Wherein, reference numeral 100 denotes the keyboard, and reference numerals 110, 120, and 130 sequentially denote the Scroll Lock, the Caps Lock, and the Num Lock LED indicators electrically connected to the keyboard 100.

In brief, the present invention provides a method of controlling keyboard to indicate any new incoming e-mail. In the method, a specific driver is designed to repeatedly detect any new incoming e-mail received on a computer. The driver generates a Set Keyboard State function if there is any unread incoming e-mail that has been put in an inbox. A user is informed of the unread incoming e-mail directly from the existing indicators on the keyboard connected to the computer. It does not need to add any new key to the keyboard or to modify settings and/or circuit elements for the keyboard controller. The problems of increased manufacturing cost of keyboard due to added light emitting diode or current-limiting resistor and additional expenses incurred by the user to purchase the modified keyboard are therefore avoided.

In the above paragraphs, an overall design concept of the present invention has been described in details with some preferred embodiments thereof. It is understood that other similar or functionally equivalent controlling steps and many changes and modifications in the described embodiments can be carried out by a person skilled in the art based on the illustrated flowcharts and logic circuit diagram of the present invention without departing from the scope and the spirit of the invention as defined by the appended claims.

What is claimed is:

1. A method of controlling a keyboard to indicate any incoming e-mail via a specific driver that repeatedly detects for any new incoming e-mailed received on a computer to which the keyboard is connected, so that a user is informed of such incoming e-mail via existing indicators on the keyboard, comprising the steps of:
detecting an inbox of the computer for any new incoming e-mail at specified intervals; and detecting the inbox for any unread incoming e-mail therein;
generating a Set Keyboard State function, if there is any unread incoming e-mail in the inbox, and memorizing current states of the three indicators on the keyboard, and sending out a command to the keyboard at the specified intervals, so that a user is informed of the unread incoming e-mail via the currently indicated states of the three indicators; and
closing the Set Keyboard State function and returning to the previously memorized states of the three indicators; and returning to the first step to repeat detecting the inbox of the computer for any incoming e-mail at the specified intervals and automatically informing the user of any new incoming e-mail via the existing indicators on the keyboard.

2. The method of controlling a keyboard to indicate any incoming e-mail as claimed in claim 1, wherein the Set Keyboard State function also informs the user of the incoming e-mail by emitting a voice or sound via a speaker connected to the computer or displaying a reminder on a screen of the computer via a remind-on-screen program.

3. The method of controlling a keyboard to indicate any incoming e-mail as claimed in claim 1, wherein the three indicators are three light emitting diodes (LED).

4. The method of controlling a keyboard to indicate any incoming e-mail as claimed in claim 1, wherein the computer is selected from the group consisting of desktop computer, notebook computer, and hand-held computer.
